(19) United States
(12) Patent Application Publication
(10) Pub. No.: US 2021/0240192 A1
(43) Pub. Date: Aug. 5, 2021

(54) ESTIMATION METHOD AND ESTIMATOR FOR SIDESLIP ANGLE OF STRAIGHT-LINE NAVIGATION OF AGRICULTURAL MACHINERY

(71) Applicant: Qingdao Agriculture University, Qingdao City (CN)

(72) Inventors: Jian Zhang, Qingdao City (CN); Ranbing Yang, Qingdao City (CN)

(21) Appl. No.: 17/143,449

(22) Filed: Jan. 7, 2021

(30) Foreign Application Priority Data
Jan. 17, 2020 (CN) 2020100522929

(51) Int. Cl. G05D 1/02; B62D 15/02; G05D 1/00; G05D 1/08

(52) U.S. Cl. CPC G05D 1/0223; B62D 15/021; G05D 2201/0201; G05D 1/0891; G05D 1/0088

(57) ABSTRACT

The invention discloses an estimation method and estimator for sideslip angle of straight-line navigation of agricultural machinery, which collect and analyze front wheel steering angle information, forward speed information of agricultural machinery, antenna positioning information and current attitude information. The estimation of sideslip angle is realized based on state observation theory. The first estimator, the second estimator and the third estimator are used to estimate the heading deviation of the vehicle body, position deviation and sideslip angle information. In the analysis process, integration is used instead of differentiation, which avoids the error of amplification by differential operation.

### FIELD OF THE INVENTION

The invention belongs to the field of vehicle navigation and tracking, and particularly relates to an estimation method and estimator for sideslip angle of straight-line navigation of agricultural machinery.

### BACKGROUND OF THE INVENTION

With the improvement of automation level of agricultural machinery, automatic navigation technology of agricultural machinery has been paid more and more attention, especially in dry land operation in Northeast China and Xinjiang. According to the characteristics of crop planting, the accuracy of straight-line path tracking in agricultural machinery navigation system is much higher than that of other types of navigation vehicles. But unlike the improvement of automatic navigation technology of agricultural machinery in dry land, affected by factors such as uneven hard floor and vehicle sideslip in paddy field working environment, the poor accuracy of straight-line path tracking has become the main problem that needs to be solved urgently in automatic navigation technology of paddy field agricultural machinery.

Automatic driving of agricultural machinery started late in China, and the research on sideslip has not been carried out. Improving the straight-line path tracking accuracy of automatic navigation system of agricultural machinery in paddy field is one of the main research problems of automatic navigation system of agricultural machinery at present. Path tracking algorithms for automatic navigation of agricultural machinery mostly depend on vehicle dynamics model, in which sideslip angle is one of the parameters in vehicle dynamics model. Because sideslip occurs in the contact surface between tire and land, it is difficult to obtain sideslip angle. However, most current automatic navigation path tracking algorithms for agricultural machinery have ignored the influence of sideslip angle, which leads to poor path tracking accuracy in the process of paddy field operation machinery.

Therefore, based on the state observation theory, the invention designs an agricultural machinery sideslip angle estimator, which provides parameter reference for the straight-line tracking algorithm of agricultural machinery automatic navigation path, and further provides support for improving the path tracking accuracy of agricultural machinery automatic navigation under sideslip conditions.

### SUMMARY OF THE INVENTION

The invention provides a sideslip angle estimation method and estimator suitable for agricultural machinery straight-line navigation based on the observer theory aiming at the sideslip problem existing in the straight-line path tracking process of agricultural machinery vehicles with front wheel steering.

The invention is realized by adopting the following technical schemes:

A sideslip angle estimation method suitable for straight-line navigation of agricultural machinery comprises the following steps:

S1, collecting front wheel steering angle information, forward speed information, antenna positioning information and current attitude information of the agricultural machinery during the traveling process of the agricultural machinery, and performing corresponding analysis and processing on the information.

S2, constructing a dynamic equation of agricultural machinery and taking the dynamic equation as a system state equation, and estimating the sideslip angle in the straight-line navigation path tracking process based on the state observer theory, specifically:

(1) According to the antenna positioning information and current attitude information of agricultural machinery collected in S1, analyze and obtain a comprehensive error signal ε(j) at time j:

ε(j)=k_{y}(y(j)−ŷ(j))+k_{θ}(\tilde{θ}(j)−\hat{\tilde{θ}}(j)) (3)

Among them, y(j) represents the measured value of position deviation at time j, which is recorded as the distance between navigation point coordinates and the nearest point on the route planning line, \tilde{θ}(j) indicates the measured value of heading deviation at time j, which is recorded as the difference between the heading of the vehicle and the heading of the route planning line, [symbol] (j) indicates the estimated value of heading deviation at j time, ŷ(j) estimates value of position deviation at time j, k_{y} and k_{θ} are coefficient, which is satisfied k_{θ}+k_{y}<1 and k_{θ}<k_{y}. The initial values of position deviation estimation and heading deviation estimation are both 0.

(2) According to the obtained comprehensive error signal ε(j), analyze and obtain the estimated value \hat{β}(j) of sideslip angle at time j:

\hat{β}(j)=\hat{β}(j−1)+k₁ε(j)Tₛ (4)

Among them, \hat{β}(j−1) represents the estimated value of sideslip angle at time j−1, k₁ is the coefficient, and Tₛ represents the system control period.

(3) According to the collected front wheel rotation angle information, forward speed information, comprehensive error signal ε(j) and sideslip angle estimated value \hat{β}(j), the heading deviation at time j is estimated to obtain the estimated value of heading deviation at time j:

$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$

Among them, \hat{\tilde{θ}}(j−1) represents the estimated value of heading deviation at time j−1, ν(j) is the current forward speed of the vehicle, L is the length of the vehicle body, δ(j) δ(j) is the current front wheel steering angle, and k₂ is the coefficient.

(4) According to the collected forward speed information of agricultural machinery, the estimated value of heading deviation, the estimated value of sideslip angle and the comprehensive error signal obtained by analysis, the position deviation of heading is estimated to obtain the estimated value of position deviation:

ŷ(j)=ŷ(j−1)+Tₛ[ν(j)ₛᵢₙ(\hat{\tilde{θ}}(j)+\hat{β}(j))+k₃ε(j)] (6)

Among them, ŷ(j−1) represents the estimated value of position deviation at time j−1, and k₃ is the coefficient.

Further, in S1, when analyzing and processing the collected data, the following methods are specifically adopted:

(1) The collected front wheel steering angle information is A/D converted and filtered to obtain the digital value δ(j) of the front wheel steering angle at time j.

(2) Filtering the collected forward speed information of agricultural machinery to obtain the current forward speed ν(j) at time j.

(3) Through coordinate transformation and analysis of the collected antenna positioning information and current vehicle attitude information, the position deviation measurement value y(j) and heading deviation measurement value \tilde{θ}(j) between the navigation point coordinate information and the path planning line are obtained. The position deviation measure value y(j) at time j is defined as that distance between the coordinate of the navigation point and the nearest point on the path planning line. The heading deviation measured value \tilde{θ}(j) is the difference between the heading of the vehicle at time j and the heading of the route planning line.

Further, in S2, the dynamic equation of the agricultural machinery constructed is as follows:

$$\{ \begin{matrix}\dot{y} = v sin ( \tilde{θ} + β ) \\ \dot{\tilde{θ}} = \frac{v}{L} [ cos β ( tan ( δ + β ) - tan β ) ]\end{matrix} \qquad ( 2 )$$

Among them, δ indicates the front wheel angle, L indicates the length of agricultural machinery body, ν indicates the forward speed of the vehicle, β indicates the sideslip angle and \tilde{θ} indicates the heading deviation, and y indicates the position deviation, \dot{y} and \dot{\tilde{θ}} respectively represent the first order reciprocal of the position deviation and the heading deviation.

In addition, the invention also provides a sideslip angle estimator suitable for straight-line navigation of agricultural machinery, wherein the automatic navigation system of agricultural machinery comprises a vehicle front wheel angle sensor and a GNSS positioning and orientation device, and the sideslip angle estimator comprises a comprehensive error calculator, a first estimator, a second estimator and a third estimator.

The front wheel angle sensor is used for collecting front wheel steering angle information, and the front wheel steering angle information is processed and transmitted to the input end of the second estimator. The GNSS positioning and orientation device is used for collecting forward speed information, antenna positioning information and current attitude information of agricultural machinery, and the collected forward speed information is also transmitted to the input end of the second estimator after being filtered. The acquired antenna positioning information and the current vehicle attitude information are analyzed and calculated to obtain the position deviation measurement value y(j) and the heading deviation measurement value \tilde{θ}(j) between the navigation point coordinate information and the path planning line, which are transmitted to the input end of the comprehensive error calculator.

The output end of the comprehensive error calculator is respectively connected with the input ends of the first estimator, the second estimator and the third estimator. The output end of the first estimator is respectively connected with the input ends of the second estimator and the third estimator. The output end of the second estimator is respectively connected with the input ends of the comprehensive error calculator and the third estimator. The output end of the third estimator is connected with the input end of the comprehensive error calculator.

The comprehensive error calculator is used for analyzing and obtaining a comprehensive error signal ε(j) at time j, namely:

ε(j)=k_{y}(y(j)−ŷ(j))+k_{θ}(\tilde{θ}(j)−\hat{\tilde{θ}}(j)) (3)

Among them, [symbol] (j) indicates the heading deviation estimation value ŷ(j) indicates position deviation estimation value, k_{y} and k_{θ} are coefficients, satisfying k_{θ}+k_{y}<1 and k_{θ}<k_{y}. The estimated value of position deviation is obtained according to the third estimator, and the estimated value of heading deviation is obtained according to the second estimator, and its initial values are all 0.

The first estimator estimates the sideslip angle estimated value \hat{β}(j) at time j, i.e.:

\hat{β}(j)=\hat{β}(j−1)+k₁ε(j)Tₛ (4)

Among them, k₁ is the coefficient, and Tₛ represents the system control period.

The second estimator is used for estimating the heading deviation at time j to obtain an the heading deviation estimated value, namely:

$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$

Among them, ν(j) is the current speed of the vehicle, L is the length of the vehicle body, δ(j) is the current front wheel steering angle, and k₂ is the coefficient.

The third estimator estimates the position deviation of the heading to obtain an estimated value of the position deviation, namely:

ŷ(j)=ŷ(j−1)+Tₛ[ν(j)ₛᵢₙ(\hat{\tilde{θ}}(j)+\hat{β}(j))+k₃ε(j)] (6)

Among it, k₃ is the coefficient.

Furthermore, the output end of the front wheel angle sensor is sequentially connected with the input end of the second estimator through an A/D converter and a first digital filter, and the first digital filter is used for filtering the front wheel steering angle signal converted by the A/D converter.

Compared with the prior art, the invention has the advantages and positive effects that:

This scheme realizes the estimation of sideslip angle based on state observation theory, which does not need to add extra hardware, has low calculation amount and is convenient for low-cost embedded systems such as MCU and ARM. Three state observers are used to estimate the heading deviation, position deviation and sideslip angle of the vehicle body, and integration is used instead of differentiation in the analysis process to avoid the amplification of error by differential operation. In addition, the estimation of heading deviation and position deviation is completed while the sideslip angle is obtained, and the filtering function is provided by itself, which improves the problems such as larger error deviation of heading deviation and position deviation acquisition caused by the delay in updating positioning information.

### BRIEF DESCRIPTION OF THE FIGURES

FIG. 1 is a schematic block diagram of a sideslip angle estimator according to an embodiment of the invention.

FIG. 2 is a schematic diagram of straight-line navigation according to an embodiment of the invention.

FIG. 3 is a schematic block diagram of a comprehensive error calculator according to an embodiment of the invention.

FIG. 4 is a schematic block diagram of the first estimator according to the invention.

FIG. 5 is a schematic block diagram of the second estimator according to the invention.

FIG. 6 is a schematic block diagram of the third estimator according to the invention.

FIG. 7 is a precision data diagram of linear path tracking for sideslip angle estimation based on the traditional method.

FIG. 8 is a test data diagram of sideslip angle estimation according to the invention.

FIG. 9 is a precision data diagram of the tracking of the straight-line navigation path using the sideslip angle compensation of the invention.

### DESCRIPTION OF THE INVENTION

In order to understand the above objects, features and advantages of the present invention more clearly, the invention will be further explained with reference to the drawings and examples. It should be noted that the embodiments of this application and the features in the embodiments can be combined with each other without conflict.

The invention designs a sideslip angle estimation method and estimator suitable for agricultural machinery linear navigation based on wheel angle measurement information, vehicle forward speed and vehicle dynamics model by using an observer theory.

Embodiment 1, a sideslip angle estimation method suitable for straight-line navigation of agricultural machinery, specifically comprises the following steps:

S1, collecting front wheel steering angle information, forward speed information, antenna positioning information and current attitude information of the agricultural machinery during the traveling process of the agricultural machinery, and performing corresponding analysis and processing on the information.

S2, constructing a dynamic equation of agricultural machinery and taking it as a system state equation, and estimating the sideslip angle in the straight-line navigation path tracking process based on the state observer theory, specifically:

(1) According to the antenna positioning information and current attitude information of agricultural machinery collected in S1, analyze and obtain a comprehensive error signal ε(j) at time j:

ε(j)=k_{y}(y(j)−ŷ(j))+k_{θ}(\tilde{θ}(j)−\hat{\tilde{θ}}(j)) (3)

Among them, y(j) represents the measured value of position deviation at time j, which is recorded as the distance between navigation point coordinates and the nearest point on the route planning line, \tilde{θ}(j) indicates the measured value of heading deviation at time j, which is recorded as the difference between the heading of the vehicle and the heading of the route planning line, [symbol] (j) indicates the estimated value of heading deviation at j time, ŷ(j) estimates value of position deviation at time j, k_{y} and k_{θ} are coefficient, which is satisfied k_{θ}+k_{y}<1 and k_{θ}<k_{y}. The initial values of position deviation estimation and heading deviation estimation are both 0.

(2) According to the obtained comprehensive error signal ε(j), analyze and obtain the estimated value \hat{β}(j) of sideslip angle at time j:

\hat{β}(j)=\hat{β}(j−1)+k₁ε(j)Tₛ (4)

Among them, \hat{β}(j−1) represents the estimated value of sideslip angle at time j−1, k₁ is the coefficient, and Tₛ represents the system control period.

(3) According to the collected front wheel rotation angle information, forward speed information, comprehensive error signal ε(j) and sideslip angle estimated value \hat{β}(j), the heading deviation at time j is estimated to obtain the estimated value of heading deviation at time j:

$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$

Among them, \hat{\tilde{θ}}(j−1) represents the estimated value of heading deviation at time j−1, ν(j) is the current forward speed of the vehicle, L is the length of the vehicle body, δ(j) δ(j) is the current front wheel steering angle, and k₂ is the coefficient.

(4) According to the collected forward speed information of agricultural machinery, the estimated value of heading deviation, the estimated value of sideslip angle and the comprehensive error signal obtained by analysis, the position deviation of heading is estimated to obtain the estimated value of position deviation:

ŷ(j)=ŷ(j−1)+Tₛ[ν(j)ₛᵢₙ(\hat{\tilde{θ}}(j)+\hat{β}(j))+k₃ε(j)] (6)

Among them, ŷ(j−1) represents the estimated value of position deviation at time j−1, and k₃ is the coefficient.

In the step S1, data is collected by the vehicle front wheel angle sensor and GNSS positioning orientation device installed on the automatic navigation system of agricultural machinery, and the collected data is analyzed and processed in the following ways:

(1) Performing A/D conversion and filtering processing on collected front wheel steering angle information to obtain the front wheel steering angle digital value δ(j) at time j. Here, mean filtering is adopted. If the number of filter points of mean filtering is defined as N, the sampling interval of A/D conversion is defined as Δt, and the system control period is defined as Tₛ, then the mean filtering points N satisfies the relation:

N<0.5Tₛ/Δt

(2) Performing secondary filtering on the collected forward speed information of agricultural machinery to obtain the current forward speed ν(j) at time j.

(3) Coordinate transformation and analysis are carried out on the acquired antenna positioning information and current vehicle attitude information:

Coordinate transformation is completed in two steps:

1. Gauss-Kruger projection, which is converted from longitude and latitude elevation of geodetic reference coordinate system to geocentric-solid coordinate system.

2. The Euler coordinate transformation module calculates the coordinate information of the vehicle center point in the navigation coordinate system according to the coordinate information of the positioning antenna in the car body coordinate system and the vehicle attitude information (hereinafter referred to as the navigation point coordinate).

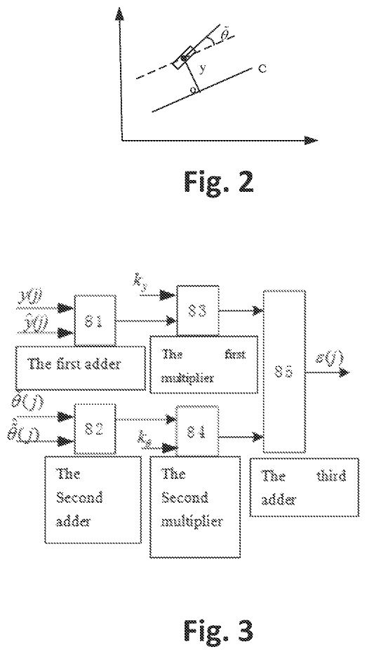

The navigation point coordinate information is obtained by coordinate change, and the position deviation measurement value y(j) and heading deviation measurement value \tilde{θ}(j) between the navigation point coordinate information and the route planning line are obtained by analysis. As shown in FIG. 2, the position deviation measured value y(j) at time j is defined as the distance between the coordinates of navigation points and the nearest point on the route planning line, and the heading deviation measured value \tilde{θ}(j) is the difference between the vehicle heading at time j and the heading of the route planning line.

According to the knowledge of modern control theory, an accurate dynamic model is the premise and foundation for realizing accurate path tracking of navigation. In the process of linear path tracking, the dynamic equation of agricultural machinery constructed in step S2 is as follows:

$$\{ \begin{matrix}\dot{y} = {v}_{sin} ( \tilde{θ} + β ) \\ \dot{\tilde{θ}} = \frac{v}{L} [ cos β ( tan ( δ + β ) - tan β ) ]\end{matrix} \qquad ( 2 )$$

In which, δ represents the front wheel angle, L represents the length of agricultural machinery body, ν represents the forward speed of vehicle, β represents sideslip angle, \tilde{θ} represents heading deviation, y represents position deviation, and \dot{y} and \dot{\tilde{θ}} represent the first derivative of position deviation and heading deviation.

In practical application, sideslip occurs at the contact surface between land parcel and wheels, so it is difficult to use sideslip information with sensors. This scheme is beneficial to the state observer theory, and formula (2) is taken as the system state equation in the design process of this scheme. In the process of agricultural machinery linear path tracking, there are two deviation information: position deviation and heading deviation, and both deviation information are measurable. In order to make the measurement information fully contain the current coordinate information of the vehicle body, the measurement equation of this scheme adopts the linear combination of position deviation and heading deviation. According to the system state equation and measurement equation, the sideslip information is estimated.

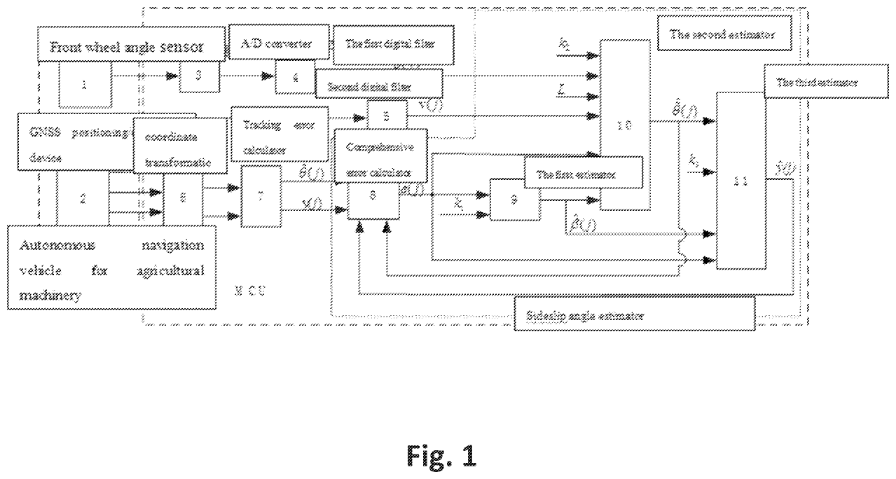

Embodiment 2: based on the estimation method proposed in embodiment 1, this embodiment proposes a sideslip angle estimator suitable for straight-line navigation of agricultural machinery. The automatic navigation system of agricultural machinery is equipped with a vehicle front wheel angle sensor 1 and a GNSS positioning and orientation device 2. As shown in FIG. 1, the analog value of the front wheel steering angle output by the front wheel angle sensor 1 passes through an A/D converter 3 and a first digital filter 4 and then outputs the front wheel steering angle digital value δ(j) at time j. The first digital filter 4 filters the signal after A/D conversion of the wheel angle sensor, which is mean filtering. The filter points of mean filtering are defined as N, the sampling interval of AD conversion is defined as Δt, and the system control period is defined as Tₛ. In order to ensure the normal operation of the system, the mean filter points N satisfy the relation:

N<0.5Tₛ/Δtₒ

GNSS positioning/orientation device 2 is used to collect the forward speed information, antenna positioning information and current attitude information of agricultural machinery: the forward speed information ν output by GNSS is filtered by a second digital filter 5 to obtain the forward speed at time j, and the second digital filter 5 is a second-order low-pass filter. The antenna positioning information and the current vehicle attitude information output by it are analyzed and calculated by the coordinate transformation module 6 and the tracking error calculator 7 to obtain the position deviation measured value y(j) and the heading deviation measured value \tilde{θ}(j) between the navigation point coordinate information and the path plan C.

The coordinate transformation module 6 is completed by two steps:

1. Gauss-Kruger projection, which is converted from longitude and latitude elevation of geodetic reference coordinate system to geocentric-solid coordinate system.

2. Euler coordinate transformation module calculates the coordinate information of the vehicle center point in the navigation coordinate system according to the coordinate information of the positioning antenna in the car body coordinate system and the vehicle attitude information (hereinafter referred to as the navigation point coordinate).

Based on the acquired antenna positioning information (including longitude, latitude and elevation) and current attitude information (heading, roll and pitch) in the geodetic reference coordinate system, the coordinate transformation module 6 includes Gauss-Kruger projection transformation and Euler coordinate transformation, aiming at obtaining the projection point coordinate information of the vehicle center point in the navigation coordinate system according to the vehicle attitude information and antenna positioning information. According to the definition of the navigation coordinate system, the GNSS positioning/orientation device 2 outputs the longitude, latitude and elevation positioning information of the positioning antenna in the geodetic reference coordinate system. By using Gauss-Kruger projection, the longitude, latitude and elevation of the positioning antenna in geodetic reference coordinate system are converted into x, y and z coordinate information in geocentric-solid coordinate system, which is recorded as (px, py, pz). Selecting the geocentric-geosynthetic coordinate system as the navigation coordinate system, which adopts the conventional northeast sky coordinate system, i.e., the x axis is in the east direction, the y axis is in the north direction, and the z axis is perpendicular to the xy plane and points to the sky direction. The vehicle center point is defined as the coordinate origin o′ of the vehicle body coordinate system, the vehicle head direction is the longitudinal axis y′ of the vehicle body coordinate system, the direction perpendicular to the car head from the coordinate origin o′ to the right side of the car body is the transverse axis x′ of the car body coordinate system, and according to the right-hand rule, the sky direction perpendicular to the vehicle body from the coordinate origin is the vehicle body coordinate system z′. The coordinates of the GNSS positioning antenna installed in the car body coordinate system are known, which are recorded as (νₓ,ν_{y},ν_{z}). As mentioned above, the attitude information of the car body, including roll, pitch and heading, is recorded as (roll, pitch, yaw). According to the basic principle of Euler transformation, the coordinate information (x,y,z) of the center point of the vehicle in the navigation coordinate system can be obtained by using Euler transformation (hereinafter referred to as navigation point coordinate). Considering that this coordinate transformation technology is relatively mature, it will not be described in detail here.

After coordinate transformation is completed, the tracking error calculator 7 calculates the position deviation measured values y(j) and heading deviation measured values \tilde{θ}(j) between navigation point coordinates and path planning line C. As shown in the schematic diagram of agricultural machinery straight-line path tracking in FIG. 2, the position deviation y(j) at time J is defined as the distance between navigation point coordinates and the nearest point o on path planning line C, and the heading deviation \tilde{θ}(j) is the difference between vehicle heading and C heading at J time.

It should be noted that agricultural machinery is a rigid body. Compared with dry field machinery, paddy field machinery, especially sprayers and rice transplanters, is smaller and usually operates at a speed of less than 8 km/h. In this scheme, agricultural machinery works in straight-line tracking, and the steering angle of vehicles is small, so it is approximately assumed that front and rear wheel sideslip occurs at the same time and the sideslip angle is the same.

With continued reference to FIG. 1, the sideslip angle estimator includes a comprehensive error calculator 8, a first estimator 9, a second estimator 10 and a third estimator 11, which interact to obtain a heading deviation estimated value, a position deviation estimated value and a sideslip angle estimated value.

According to the knowledge of modern control theory, an accurate dynamic model is the premise and foundation for realizing accurate path tracking of navigation. On the premise that the front and rear wheel sideslip angles are the same, the curvature radius of agricultural machinery is defined as c(s), and the front wheel angle is defined as δ, and the dynamic equation of agricultural machinery can be described as:

$$\{ \begin{matrix}\dot{y} = {v}_{sin} ( \tilde{θ} + {β}^{r} ) \\ \dot{\tilde{θ}} = v [ {cos β}^{r} \frac{tan ( δ + β ) - tan β}{L} - \frac{c ( s ) cos ( \tilde{θ} + β )}{1 - c ( s ) y} ]\end{matrix} \qquad ( 1 )$$

In the process of linear path tracking, the radius of curvature can be approximated by c(s)=0, and Formula 1 is simplified as:

$$\{ \begin{matrix}\dot{y} = {v}_{sin} ( \tilde{θ} + β ) \\ \dot{\tilde{θ}} = \frac{v}{L} [ cos β ( tan ( δ + β ) - tan β ) ]\end{matrix} \qquad ( 2 )$$

However, in practical application, sideslip occurs at the contact surface between land parcel and wheels, so it is difficult to use sideslip information with sensors. This scheme is beneficial to the state observer theory, and designs a sideslip information estimator suitable for the straight-line path tracking process of agricultural machinery. Formula (2) is used as the system state equation in the design process of this scheme. In the process of agricultural machinery linear path tracking, there are two deviation information: position deviation and heading deviation, and both deviation information are measurable. In order to make the measurement information fully contain the current coordinate information of the vehicle body, the measurement equation of this scheme adopts the linear combination of position deviation and heading deviation. According to the system state equation and measurement equation, an observer is designed to estimate the sideslip information, specifically:

As shown in FIG. 3, the comprehensive error calculator 8 includes a first adder 81, a second adder 82, a first multiplier 83, a second multiplier 84 and a third adder 85. According to the measured value of position and heading deviation and the estimated value of position and heading deviation, the comprehensive error calculator 8 calculates and obtains the comprehensive error signal at time j, namely:

ε(j)=k_{y}(y(j)−ŷ(j))+k_{θ}(\tilde{θ}(j)−\hat{\tilde{θ}}(j)) (3)

Among them, [symbol] (j) indicates the heading deviation estimated value at time J and ŷ(j) indicates the position deviation estimated value at time J, and the initial values of both the position deviation estimated value and the heading deviation estimated value are 0, in order to ensure the stability of the system, k_{θ} and k_{y} meet the relational expressions k_{θ}+k_{y}<1. Because sideslip is mainly reflected in the vehicle body position deviation information, therefore, select k_{θ}<k_{y}.

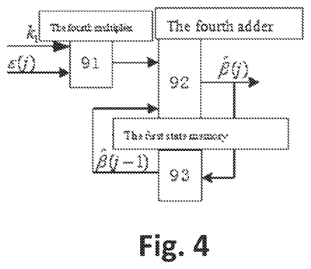

As shown in FIG. 4, the first estimator 9 includes a fourth multiplier 91, a fourth adder 92 and a first state memory 93, and the first state memory 93 records the estimated value of the sideslip angle at the previous time as follows: the first estimator 9 completes the estimation of the estimated sideslip angle at time j, i.e.:

\hat{β}(j)=\hat{β}(j−1)+k₁ε(j)Tₛ (4)

Tₛ represents the system control period.

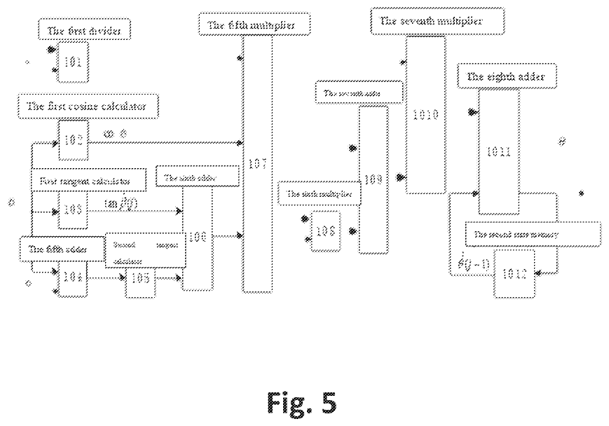

As shown in FIG. 5, the second estimator 10 includes a first divider 101, a first cosine calculator 102, a first tangent calculator 103, a fifth adder 104, a second tangent calculator 105, a sixth adder 106, a fifth multiplier 107, a sixth multiplier 108, a seventh adder 109, a seventh multiplier 1010, an eighth adder 1011 and a second state memory 1012. The second state memory 1012 records the heading deviation estimated value \hat{\tilde{θ}}(j−1) at the previous time. The second estimator 10 estimates the heading deviation \tilde{θ}(j) at time j according to the current speed ν(j) of the vehicle, the length of the vehicle body L and the current wheel angle δ(j), that is:

$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$

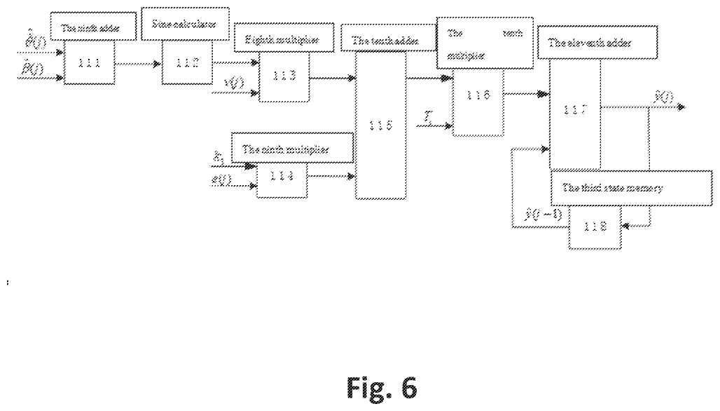

As shown in FIG. 6, the third estimator 11 includes a ninth adder 111, a sine calculator 112, an eighth multiplier 113, a ninth multiplier 114, a tenth adder 115, a tenth multiplier 116, an eleventh adder 117, and a third state memory 118 which records the position deviation estimated value ŷ(j−1) at the previous time. The third estimator 11 completes the estimation of the heading position deviation, namely:

ŷ(j)=ŷ(j−1)+Tₛ[ν(j)ₛᵢₙ(\hat{\tilde{θ}}(j)+\hat{β}(j))+k₃ε(j)] (6)

To sum up, this scheme realizes the estimation of sideslip angle based on state observation theory, which does not need to add extra hardware, has low calculation amount and is convenient for low-cost embedded systems such as MCU and ARM. Three state observers are used to estimate the heading deviation, position deviation and sideslip angle of the vehicle body, and integration is used instead of differentiation in the analysis process to avoid the amplification of error by differential operation. In addition, the estimation of heading deviation and position deviation is completed while the sideslip angle is obtained, and the filtering function is provided by itself, which improves the problems such as larger error deviation of heading deviation and position deviation acquisition caused by the delay in updating positioning information.

### Test Verification:

In order to verify the effect of this scheme, a physical test was carried out: the test site was Zengcheng Experimental Base of South China Agricultural University in Guangzhou, and the test plot was paddy field. After the previous manual driving vehicle test, there was a noticeable sideslip phenomenon in some areas. The test vehicle was Revo four-wheel drive high gap sprayer ZP9500, which used Hall sensor to measure the wheel angle. The sensor model was RF4000-120 produced by NOVOTECHNIK Company in Germany, the linear path tracking algorithm is a feedback control rate designed on the basis of the nonlinear model of vehicle chain. The output of the control rate is described by mathematical formula as follows:

$${\hat{δ}}_{f} ( j ) = {tan}^{- 1} \{ tan ( δ ( j ) - β ( j ) ) - \frac{L}{cos ( δ ( j ) - β ( j ) )} ( {λ}_{1} y ( j ) + {λ}_{2} {tan ψ}_{e} ( j ) ) {cos}^{3} {ψ}_{e} ( j ) \} + β ( j ) \qquad ( 7 )$$

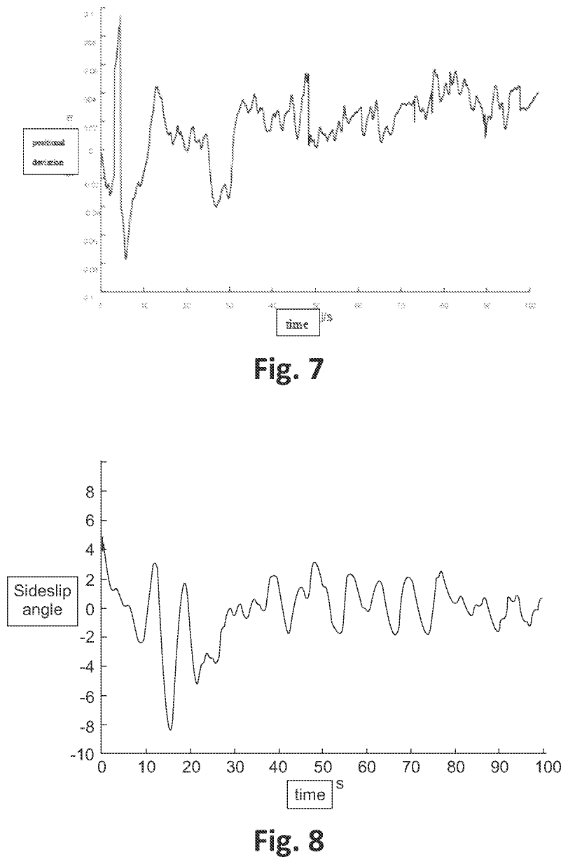

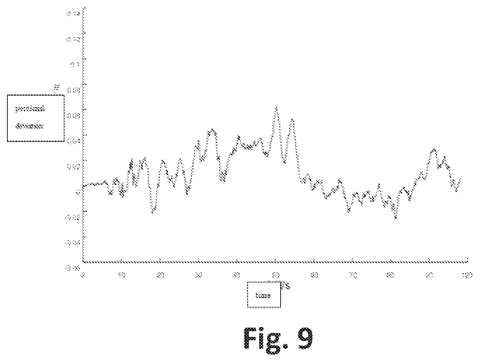

Among them, \hat{δ}_{f}(j) is the desired wheel angle output by the path tracking algorithm at time J. ψₑ(j) is the difference between the current target heading and the actual heading; λ₁ and λ₂ is the control coefficient. In the test, λ₁=1.42, λ₂=5.78, the sideslip angle is not estimated, that is, in equation 7 β(j)=0, the accuracy data graph of straight-line path tracking is shown in FIG. 7, and the accuracy is about 10 cm. The data map of sideslip angle estimation using the algorithm of the present invention is shown in FIG. 8, and the parameters of the estimator are selected as follows: k_{y}=0.6, k_{θ}=0.3, Tₛ=0.02 s, k₁=14, k₂=128, k₃=1000. The estimated angle value is brought into equation (7) to realize straight-line path tracking. As shown in FIG. 9, the path tracking accuracy is about 6 cm, and the large-angle sideslip angle is suppressed. It should be noted that the overall position deviation in the test data is biased, which is caused by the installation error between the antenna installation and the vertical angle of the vehicle body. During the operation of the navigation system, the usual solution is to adjust the overall offset value of the navigation control line. take FIGS. 7 and 9 as examples. If the forward offset is about 2 cm, the tracking control line is 2 cm to the left. After this treatment, the overall position error offset will not affect the navigation control accuracy in the production operation process. After this adjustment, the position deviation is still about 10 cm before sideslip compensation, and after compensation, the position deviation is about 4 cm. The invention can obviously improve the navigation accuracy of straight-line navigation in paddy field operation.

The above is only a preferred embodiment of the present invention, and it is not meant to limit the present invention in other forms. Any person familiar with this profession may use the technical content disclosed above to change or modify the equivalent embodiment to be applied in other fields. However, any simple modification, equivalent change and modification made to the above embodiment according to the technical essence of the present invention without departing from the technical content of the present invention still belongs to the protection scope of the technical scheme of the present invention.

1. A sideslip angle estimation method suitable for straight-line navigation of agricultural machinery is characterized in that it includes the following steps:
S1, collecting front wheel steering angle information, forward speed information, antenna positioning information and current attitude information of the agricultural machinery during the traveling process of the agricultural machinery, and performing corresponding analysis and processing on the information;
S2, constructing a dynamic equation of agricultural machinery and taking the dynamic equation as a system state equation, and estimating the sideslip angle in the straight-line navigation path tracking process based on the state observer theory, specifically:
(1) according to the antenna positioning information and current attitude information of agricultural machinery collected in S1, analyze and obtain a comprehensive error signal ε(j) at time j:
ε(j)=k_{y}(y(j)−ŷ(j))+k_{θ}(\tilde{θ}(j)−\hat{\tilde{θ}}(j)) (3)
among them, y(j) represents the measured value of position deviation at time j, which is recorded as the distance between navigation point coordinates and the nearest point on the route planning line, \tilde{θ}(j) indicates the measured value of heading deviation at time j, which is recorded as the difference between the heading of the vehicle and the heading of the route planning line, \hat{\tilde{θ}}(j) indicates the estimated value of heading deviation at j time, ŷ(j) estimates value of position deviation at time j, k_{y} and k_{θ} are coefficient, which is satisfied k_{θ}+k_{y}<1 and k_{θ}<k_{y}. The initial values of position deviation estimation and heading deviation estimation are both 0;
(2) according to the obtained comprehensive error signal ε(j), analyze and obtain the estimated value \hat{β}(j) of sideslip angle at time j:
\hat{β}(j)=\hat{β}(j−1)+k₁ε(j)Tₛ (4)
among them, \hat{β}(j−1) represents the estimated value of sideslip angle at time j−1, k₁ is the coefficient, and Tₛ represents the system control period;
(3) according to the collected front wheel rotation angle information, forward speed information, comprehensive error signal ε(j) and sideslip angle estimated value \hat{β}(j), the heading deviation at time j is estimated to obtain the estimated value of heading deviation at time j:
$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$
among them, \hat{\tilde{θ}}(j−1) represents the estimated value of heading deviation at time j−1, ν(j) is the current forward speed of the vehicle, L is the length of the vehicle body, δ(j) δ(j) is the current front wheel steering angle, and k₂ is the coefficient.
(4) according to the collected forward speed information of agricultural machinery, the estimated value of heading deviation, the estimated value of sideslip angle and the comprehensive error signal obtained by analysis, the position deviation of heading is estimated to obtain the estimated value of position deviation:
ŷ(j)=ŷ(j−1)+Tₛ[ν(j)ₛᵢₙ(\hat{\tilde{θ}}(j)+\hat{β}(j))+k₃ε(j)] (6)
among them, ŷ(j−1) represents the estimated value of position deviation at time j−1, and k₃ is the coefficient.

2. The sideslip angle estimation method suitable for straight-line navigation of agricultural machinery according to claim 1, characterized in that in step S1, when analyzing and processing the collected data, the following methods are specifically adopted:
(1) The collected front wheel steering angle information is A/D converted and filtered to obtain the digital value δ(j) of the front wheel steering angle at time j;
(2) Filtering the collected forward speed information of agricultural machinery to obtain the current forward speed ν(j) at time j;
(3) Through coordinate transformation and analysis of the collected antenna positioning information and current vehicle attitude information, the position deviation measurement value y(j) and heading deviation measurement value \tilde{θ}(j) between the navigation point coordinate information and the path planning line are obtained. The position deviation measure value y(j) at time j is defined as that distance between the coordinate of the navigation point and the nearest point on the path planning line. The heading deviation measured value \tilde{θ}(j) is the difference between the heading of the vehicle at time j and the heading of the route planning line.

3. The sideslip angle estimation method suitable for straight-line navigation of agricultural machinery according to claim 1, characterized in that the dynamic equation of agricultural machinery constructed in step S2 is:
$$\{ \begin{matrix}\dot{y} = v sin ( \tilde{θ} + β ) \\ \dot{\tilde{θ}} = \frac{v}{L} [ cos β ( tan ( δ + β ) - tan β ) ]\end{matrix} \qquad ( 2 )$$
among them, δ indicates the front wheel angle, L indicates the length of agricultural machinery body, ν indicates the forward speed of the vehicle, β indicates the sideslip angle and \tilde{θ} indicates the heading deviation, and y indicates the position deviation, \dot{y} and \dot{\tilde{θ}} respectively represent the first order reciprocal of the position deviation and the heading deviation.

4. The sideslip angle estimation method suitable for straight-line navigation of agricultural machinery according to claim 2 is characterized in that: when filtering the collected front wheel steering angle information, mean filtering is adopted, and the filter points of mean filtering are defined as N, the sampling interval of A/D conversion is Δt, and the system control period is Tₛ, then the mean filter points N satisfy the relational expression:
N<0.5Tₛ/Δtₒ

5. The invention relates to a sideslip angle estimator suitable for straight-line navigation of agricultural machinery. The automatic navigation system of agricultural machinery comprises a vehicle front wheel angle sensor (1) and a GNSS positioning and orientation device (2), and is characterized in that the sideslip angle estimator comprises a comprehensive error calculator (8), a first estimator (9), a second estimator (10) and a third estimator (11).
the front wheel angle sensor (1) is used for collecting front wheel steering angle information, and the front wheel steering angle information is processed and transmitted to the input end of the second estimator (10). The GNSS positioning and orientation device (2) is used for collecting forward speed information, antenna positioning information and current attitude information of agricultural machinery, and the collected forward speed information is filtered and transmitted to the input end of the second estimator (10). After analyzing and calculating the collected antenna positioning information and current vehicle attitude information, the position deviation measurement value y(j) and heading deviation measurement value \tilde{θ}(j) between the navigation point coordinate information and the path planning line are obtained and transmitted to the input end of the comprehensive error calculator (8);
the output end of the comprehensive error calculator (8) is respectively connected with the input ends of the first estimator (9), the second estimator (10) and the third estimator (11). The output end of the first estimator (9) is respectively connected with the input ends of the second estimator (10) and the third estimator (11). The output end of the second estimator (10) is respectively connected with the input ends of the comprehensive error calculator (8) and the third estimator (11). The output end of the third estimator (11) is connected with the input end of the comprehensive error calculator (8);
the comprehensive error calculator (8) is used for analyzing and obtaining a comprehensive error signal ε(j) at time j, namely:
ε(j)=k_{y}(y(j)−ŷ(j))+k_{θ}(\tilde{θ}(j)−\hat{\tilde{θ}}(j)) (3)
among them, [symbol] (j) indicates the heading deviation estimation value. ŷ(j) indicates position deviation estimation value, k_{y} and k_{θ} are coefficients, satisfying k_{θ}+k_{y}<1 and k_{θ}<k_{y}. The estimated value of position deviation is obtained according to the third estimator (11), and the estimated value of heading deviation is obtained according to the second estimator (2), and its initial values are all 0;
the first estimator estimates (9) the sideslip angle estimated value \hat{β}(j) at time j, i.e.:
\hat{β}(j)=\hat{β}(j−1)+k₁ε(j)Tₛ (4)
among them, k₁ is the coefficient, and Tₛ represents the system control period;
the second estimator (10) is used for estimating the heading deviation at time j to obtain an the heading deviation estimated value, namely:
$$\hat{\tilde{θ}} ( j ) = \hat{\tilde{θ}} ( j - 1 ) + {T}_{s} \{ \frac{v ( j )}{L} ( j ) [ tan ( δ ( j ) + \hat{β} ( j ) ) - ( j ) ] + {k}_{2} ɛ ( j ) \} \qquad ( 5 )$$
among them, ν(j) is the current speed of the vehicle, L is the length of the vehicle body, δ(j) is the current front wheel steering angle, and k₂ is the coefficient;
the third estimator (11) estimates the position deviation of the heading to obtain an estimated value of the position deviation, namely:
ŷ(j)=ŷ(j−1)+Tₛ[ν(j)ₛᵢₙ(\hat{\tilde{θ}}(j)+\hat{β}(j))+k₃ε(j)] (6)
among it, k₃ is the coefficient.

6. The sideslip angle estimator suitable for straight-line navigation of agricultural machinery according to claim 5, characterized in that the output end of the front wheel angle sensor (1) is connected with the input end of the second estimator (10) through the A/D converter (3) and the first digital filter (4) in turn, and the first digital filter (4) is used for realizing the estimation of the front wheel after being converted by the A/D converter (3).

7. The sideslip angle estimator suitable for straight-line navigation of agricultural machinery according to claim 6, which is characterized in that if the filter points of the first digital filter (4) are N, the sampling interval of the A/D converter (3) is Δt, and the control period of the automatic navigation system is Tₛ, then the filter points N satisfy the relational expression:
N<0.5Tₛ/Δt

8. The sideslip angle estimator suitable for straight-line navigation of agricultural machinery according to claim 5, characterized in that one end of the output end of the GNSS positioning and orientation device (2) is connected with the input end of the second estimator (10) through a second digital filter (5), and the second digital filter (5) realizes filtering processing of the collected forward speed information;
the other end of the output end of the GNSS positioning and orientation device (2) is connected with the input end of a comprehensive error calculator (8) through a coordinate transformation module (6) and a tracking error calculator (7) in turn, wherein the coordinate transformation module (6) carries out coordinate transformation on collected information to obtain navigation point coordinate information, and the tracking error calculator (7) is used for calculating position deviation measurement value y(j) and heading deviation measurement value \tilde{θ}(j) between the navigation point coordinate information and the route planning line.
